(19) United States
(12) Patent Application Publication
(10) Pub. No.: US 2014/0096293 A1
(43) Pub. Date: Apr. 3, 2014

(54) METHOD AND APPARATUS FOR INSPECTING THERMAL ASSIST TYPE MAGNETIC HEAD

(71) Applicant: HITACHI HIGH-TECHNOLOGIES CORPORATION, Tokyo (JP)

(72) Inventors: Yoshinori KITANO, Kamisato-machi (JP); Teruaki TOKUTOMI, Kamisato-machi (JP); Naoya SAITO, Kamisato-machi (JP); Takenori HIROSE, Yokohama-shi (JP); Kaifeng ZHANG, Yokohama-shi (JP)

(73) Assignee: HITACHI HIGH-TECHNOLOGIES CORPORATION, Tokyo (JP)

(21) Appl. No.: 13/956,442

(22) Filed: Aug. 1, 2013

(30) Foreign Application Priority Data
Sep. 28, 2012 (JP) 2012-216337

(51) Int. Cl. G01Q 60/22

(52) U.S. Cl. CPC G01Q 60/22
USPC 850/32

(57) ABSTRACT

To reliably detect scattered light generated in the near field light generation area in the inspection of a thermal assist type magnetic head (herein after refer to magnetic head), the present invention provides a magnetic head inspection apparatus including: a scanning probe microscope including a cantilever having a probe with a magnetic film formed on the surface of the tip; a probe unit for supplying alternating current to a terminal formed in a magnetic head element, so that the laser beam is incident on the near field light emitting part; an imaging unit for taking an image of the probe unit and the magnetic head element; a scattered light detection unit for detecting the scattered light generated from the probe present in the generation area of the near field light of the magnetic head element, through a pinhole; and a signal processing unit for inspecting the magnetic head element.

### BACKGROUND

The present invention relates to a thermal assist type magnetic head inspection method and apparatus for inspecting a thermal assist type magnetic head. More particularly, the present invention relates to a thermal assist type magnetic head inspection method and apparatus that can inspect the generation state of near field light generated by a thermal assist type magnetic head, which may not be possible to inspect by an optical microscope or other technologies.

Apparatus for inspecting a magnetic head in a non-destructive manner uses various methods, such as optical microscope, scanning electron microscope (SEM), atomic force microscope (AFM), and magnetic force microscope (MFM).

Although the methods described above have advantages and disadvantages, the method of using a magnetic force microscope (MFM) is better than the methods of using other observation devices in that the magnetic force microscope can inspect magnetic field generated by a magnetic head to write to a hard disk in a non-destructive manner.

For example, Japanese Patent Application Laid-Open Publication No. 2010-175534 (Patent document 1) describes a method of using a magnetic force microscope (MFM) to measure the effective track width of the write track in a row-bar state in which a plurality of magnetic head elements are formed on a wafer before the individual magnetic head elements are separated from each other. In other words, Patent document 1 describes a method for generating a magnetic field by applying a current to a row-bar shaped magnetic head circuit pattern which is a sample, approaching a magnetic probe attached to a cantilever close to the generated magnetic field, and detecting the amount of displacement of the probe of the cantilever while two dimensionally scanning. In this way, two dimensional measurement of the magnetic field generated by the sample can be achieved.

Further, in the conventional magnetic head inspection, a recording signal (excitation signal) is input to a row bar-shaped thin film magnetic head, so that the state of the magnetic field generated by the recording head (element) included in the thin film magnetic head, is observed by scan shifting at the position corresponding to the flying height of the magnetic head by using a magnetic force microscope (MFM), a scanning hall probe microscope (SHPM), or a scanning magnetoresistance microscope (SMRM), in order to measure the shape of the generated magnetic field, instead of the physical shape of the recording head (element). In this way, the magnetic effective track width can be inspected in a non-destructive manner. As an example of this method, Japanese Patent Application Laid-Open Publication No. 2009-230845 (Patent document 2) describes a method of using a magnetic force microscope to measure the effective track width in a row bar state, which has been able to be inspected only in the HGA state or a simulated HGA state by a spin stand.

Meanwhile, a very high capacity is required for next-generation hard disks, so that a thermal assist type magnetic recording method has attracted attention as a new technology and has been developed by manufacturing companies. In order to increase the density and capacity of hard disks, it is necessary to narrow the track width, which is said to be close to the limit in the magnetic head of the conventional technology. However, by using a thermal assist type magnetic head with a near field light as a heat source, it is possible to reduce the track width to around 20 nm.

The thermal assist type magnetic recording head has a cross-sectional shape, in which the width in the direction perpendicular to the polarization direction of the incident light along the waveguide is gradually reduced towards the top where a near field light is generated. In this configuration, the thermal assist type magnetic recording head generates a near filed light by using a conductive structure with the width narrowing gradually or in steps towards the top where the near field light is generated in the traveling direction of the incident light. Japanese Patent Application Laid-Open Publication No. 2011-146097 (Patent document 3) describes a configuration in which a waveguide is placed next to the conductive structure to generate a near field light by a surface plasmon that is generated on the side surface of the conductive structure.

However, it is difficult to measure the effective intensity distribution and magnitude of the near field light, which is an important factor for the track width, by the surface shape obtained by an optical microscope and SEM. Thus, the inspection method is an important problem that has not been solved.

Japanese Patent Application Laid-Open Publication No. 2006-38774 (Patent document 4) discloses a “near-field optical microscope (which is also referred to as scanning near-field optical microscopy (SNOM), near-field scanning optical microscopy (NSOM), or near-field optical microscopy (NOM)). With this technology, it is possible to know the shape of the near field light that is detected by scattering the near field light by bringing a scanning probe close to the near field light.

### SUMMARY

In Patent document 1, there is described a method for measuring the two-dimensional distribution of the magnetic field formed by individual magnetic head elements of a row bar-shaped magnetic head by two-dimensional scanning with a cantilever having a probe. However, there is no description of a configuration and method for measuring the near field light and the magnetic field that are generated by the thermal assist type magnetic head.

In the conventional magnetic recording, the size of the magnetic field generation part of the head corresponds to the track width, so that the track width of the head can be inspected by measuring the magnetic field by the method described in Patent document 1. However, it is difficult to inspect a thermal assist type head in which the size of the generated near field light corresponds to the track width.

Further, also in the magnetic head inspection apparatus described in Patent document 2 for inspecting the magnetic effective track width by measuring the shape of the generated magnetic field in a row bar state, there is no description of a configuration and method for measuring the near field light and the magnetic field that are generated by the thermal assist type magnetic head.

Further, Patent document 3 describes a configuration of a thermal assist type magnetic recording head, as well as a magnetic recording apparatus including the head. However, there is no description of the method for inspecting the near field light and magnetic field generated by the thermal assist type magnetic recording head.

Still further, Patent document 4 describes a method for detecting near field light by distinguishing the near field light from other lights in the vicinity of the near field light emitting device. However, there is no description of the method for inspecting the near field light and magnetic field generated by the thermal assist type magnetic recording head.

The present invention provides a thermal assist type magnetic head element inspection method and apparatus for inspecting the magnetic field and the near field light generation area that are generated by a thermal assist type magnetic head, in order to reliably detect scattered light generated by the probe attached to the tip of a cantilever in the near field light generation area.

In order to address the above problem, according to one aspect of the present invention, there is provided a thermal assist type magnetic head inspection apparatus including: a scanning probe microscope including an XY table that can be moved in an XY plane with a thermal assist type magnetic head element placed on it, and a cantilever having a prove with a magnetic film formed on a surface of a tip portion; a probe unit for supplying an alternating current to a terminal formed in the thermal assist type magnetic head element placed on the XY table of the scanning probe microscope, so that the laser beam is incident on a near field light emitting part formed in the thermal assist type magnetic head element; an imaging unit for taking an image of the probe unit and the thermal assist type magnetic head element; an image display unit for displaying the image of the probe unit and the thermal assist type magnetic head element taken by the imaging unit; a scattered light detection unit including a light detector for detecting scattered light generated by the probe through a pinhole, when the probe is present in the generation area of the near field light generated from the near field light emitting part formed in the thermal assist type magnetic head element; and a signal processing unit for inspecting the thermal assist type magnetic head element, by using the output signal output from the scanning probe microscope by scanning the surface of the thermal assist type magnetic head element by the probe of the cantilever while the alternating current is supplied to the terminal from the probe unit, and using the output signal output from the scattered light detection unit by scanning the surface of the thermal assist type magnetic head element by the cantilever while the laser beam is incident on the near field light emitting part from the probe unit.

Further, in order to address the above problem, according to another aspect of the present invention, there is provided a thermal assist type magnetic head inspection method, including the steps of: placing a thermal assist type magnetic head element on an XY table of a scanning probe microscope including a cantilever having a probe with a magnetic film formed on the surface of the tip portion, and the XY table that can be move in the XY plane; generating a magnetic field from the thermal assist type magnetic head element by supplying an alternating current to a terminal formed in the thermal assist type magnetic head element placed on the XY table; obtaining the distribution of the magnetic field generated by scanning the surface of the thermal assist type magnetic head element, while the magnetic field is generated from the thermal assist type magnetic head element by the probe of the cantilever of the scanning probe microscope; generating a near field light from a near field light emitting part by a laser beam incident on the near field light emitting part formed in the thermal assist type magnetic head element placed on the XY table; scanning the surface of the thermal assist type magnetic head element by the probe of the cantilever of the scanning probe microscope while the near field light is generated from the near field light emitting part, to collect the scattered light generated from the probe in the generation area of the near field light by an objective lens; detecting scattered light passing through a pinhole, of the collected scattered light; obtaining the light emitting area and distribution of the near field light from the detected scattered light; and determining the quality of the thermal assist type magnetic head based on the information of the obtained distribution of the magnetic field, and on the information of the light emitting area and distribution of the near field light.

Still further, in order to address the above problem, according to another aspect of the present invention, there is provided a thermal assist type magnetic head inspection apparatus including: placing a thermal assist type magnetic head element on an XY table of a scanning probe microscope which includes a cantilever having a probe with a magnetic film formed on the surface of the tip portion as well as the XY table that can be moved in the XY plane; detecting the magnetic field generation area by scanning the surface of the thermal assist type magnetic head element by the probe of the cantilever of the scanning probe microscope in a first direction, while the magnetic field is generated in the thermal assist type magnetic head by supplying an alternating current to a terminal formed in the thermal assist type magnetic head element placed on the XY table; scanning the surface of the thermal assist type magnetic head element by the prove of the cantilever of the scanning probe microscope in a second direction opposite to the first direction, while the near filed light is generated in the thermal assist type magnetic head element by a laser beam incident on the near field light emitting part formed in the thermal assist type magnetic head element placed on the XY table, so that the scattered light generated from the probe in the generation area of the near field light is collected by an objective lens; detecting scattered light passing through a pinhole, of the collected scattered light; obtaining the near field light emitting area from the detection signal of the scattered light; and determining the quality of the thermal assist type magnetic head based on the information of the detected magnetic field generation area and on the information of the obtained near field light emitting area.

According to the aspects of the present invention, it is possible to check the position detected by the light detector through the pinhole by using an image displayed on a monitor screen, so that the positions of the probe and the pinhole can be easily adjusted. As a result, the time for the positioning can be significantly reduced compared to the case without using the monitor image with a sufficiently high accuracy in the positioning of the probe and the pinhole.

These features and advantages of the invention will be apparent from the following more particular description of preferred embodiments of the invention, as illustrated in the accompanying drawings.

### BRIEF DESCRIPTION OF THE DRAWINGS

FIG. 1A is a schematic block diagram of an inspection unit of a thermal assist type magnetic head element according to an embodiment of the present invention;

FIG. 1B is a side view of a placement unit for positioning the Y stage and a row bar mounted in the Y stage of the inspection unit of the thermal assist type magnetic head element according to an embodiment of the present invention;

FIG. 2A is a side view of a probe unit according to an embodiment of the present invention;

FIG. 2B is a perspective view of the row bar to be inspected according to an embodiment of the present invention;

FIG. 2C is a top view of the magnetic head element in which the tip portions of a probe are brought into contact with the respective electrodes of the thermal assist type magnetic head element according to an embodiment of the present invention;

FIG. 3A is a block diagram of a near field light detection optical system as well as a near field light detection control system according to an embodiment of the present invention;

FIG. 3B is an image of the thermal assist type magnetic head element including the cantilever and the probe, which is taken by a CCD camera and displayed on a monitor screen, according to an embodiment of the present invention;

FIG. 4A is a view showing the detection principle in the inspection unit of the thermal assist type magnetic head element according to an embodiment of the present invention, which is a side view of the cross section of the cantilever and the row bar in the measurement of the magnetic field generated by the magnetic head element;

FIG. 4B is a view showing the detection principle in the inspection unit of the thermal assist type magnetic head element according to an embodiment of the present invention, which is a side view of the cross section of the cantilever, the detector, and the row bar in the measurement of the near field light generated by the thermal assist type magnetic head element;

FIG. 5A is a top view of the inspection area, showing the relationship between the scan direction of the probe in the inspection area, and the magnetic field generation area and the near filed light generation area according to an embodiment of the present invention;

FIG. 5B is a top view of the inspection area, showing the relationship between the scan direction of the probe in the inspection area, and the magnetic field generation area and the near field light generation area according to an embodiment of the present invention; and

FIG. 6 is a flow chart showing the procedure of the inspection process according to an embodiment of the present invention.

### DESCRIPTION OF THE PREFERRED EMBODIMENTS

The present invention relates to a magnetic head element inspection method and apparatus for inspecting the emitting state of the near field light generated by a thermal assist type magnetic head element as well as the distribution of the magnetic field generated by the thermal assist type magnetic head element, in the state of row bar before individual thermal assist type magnetic head elements are separated from each other, or in the state of head assembly in which each of the magnetic head elements is separated from the row bar and mounted on a gimbal, by using an apparatus based on a scanning probe microscope.

Hereinafter, preferred embodiments of the present embodiment will be described with reference to the accompanying drawings, for the case of inspecting a thermal assist type magnetic head element in the state of row bar before individual thermal assist type magnetic head elements are separated from each other.

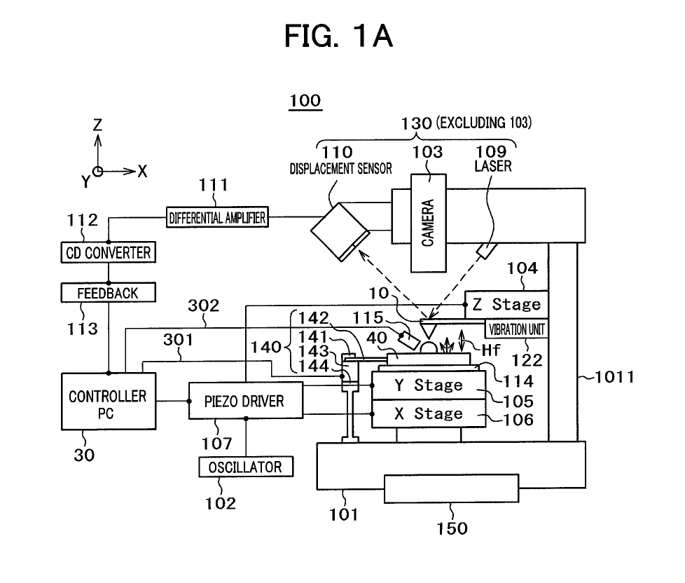

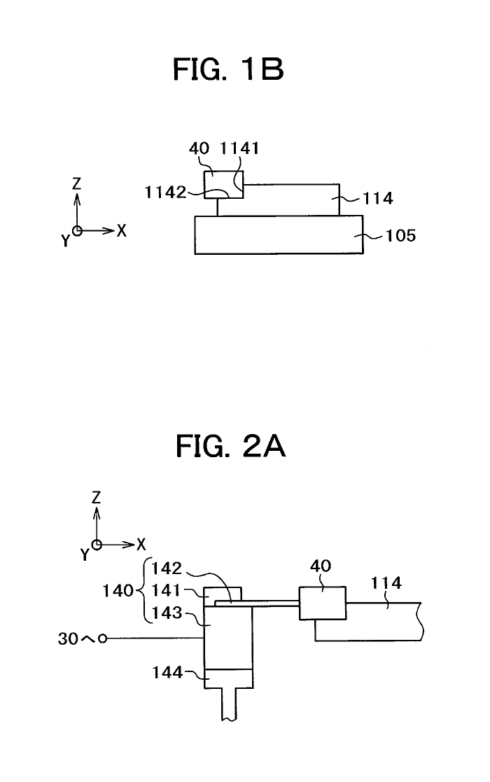

FIG. 1A shows the configuration of an apparatus for inspecting a thermal assist type magnetic head element based on the present embodiment. A thermal assist type magnetic head inspection apparatus 100 according to the present embodiment allows the measurement of the intensity distribution of near field light generated by a thermal assist type magnetic head element in the state of a row bar 40 (a block in which a plurality of head sliders are arranged in a row), in the process before a wafer in which a large number of thin film magnetic head elements are formed is processed and before a single piece of slider (thin film magnetic head chip) is cut in the manufacturing process of magnetic head elements. In general, the row bar 40 is cut from the wafer in which a large number of thin film magnetic head elements are formed as a thin block of about 3 cm to 10 cm, with about 40 to 90 head sliders (thin film magnetic head elements) arranged therein. The row bar 40 includes a laser device which is a light emission source. The magnetic head element inspection apparatus 100 according to the present embodiment is based on a scanning probe microscope. The magnetic head element inspection apparatus 100 includes an inspection stage 101, and X and Y stages 106 and 105 driven by a piezo element (not shown) that can move the row bar 40 placed on the inspection stage 101 at a short distance in the X and Y directions.

The row bar 40 is positioned in the X direction in such a way that one side surface in the long axis direction of the row bar 40 is brought into contact with a reference surface 1141 formed in a step portion 1142 of the placement unit 114 that is provided on the upper surface of the Y stage 105 to position the row bar 40. As shown in FIG. 1B, the row bar 40 is brought into contact with the side surface (reference surface) 1141 of the step portion 1142 to place a predetermined position in the Z direction and X direction. The back side surface of the row bar 40 (the surface on the opposite side of the surface in which magnetic head element electrodes 41 and 42 of the thermal assist type magnetic head element are formed) is brought into contact with the side surface (reference surface 1141) of the step portion 1142, so that the row bar 40 is positioned.

As shown in FIG. 1A, a camera 103 for measuring the amount of displacement of the row bar 40 is provided above the Y stage 105 in the magnetic head element inspection apparatus 100. A Z stage 104 is fixed to a column 1011 of the inspection stage 101 to move a cantilever 10 in the Z direction. Each of the X stage 106, the Y stage 105, and the Z stage 104 in the inspection stage 101 is realized by a piezo stage driven by a piezo element not shown.

Further, the magnetic head element inspection apparatus 100 includes a cantilever 10, a vibration unit 122, a near field light detection optical system 115, a displacement detection unit 130, a probe unit 140, an oscillator 102, a piezo driver 107, a differential amplifier 111, a DC converter 112, a feedback controller 113, and a control unit 30. Further, the control unit 30 includes a near field light detection control system 530 for controlling the near field light detection optical system 115.

The position in the Z direction of the cantilever 10 is controlled by the Z stage 104. Then, the cantilever 10 is vibrated with a predetermined frequency at a predetermined amplitude by the vibration unit 122 fixed to the Z stage 104.

The displacement detection unit 130 detects the state of vibration of the cantilever 10. The displacement detection unit 130 includes a laser light source 109 and a displacement sensor 110. The displacement detection unit 130 irradiates the cantilever 10 with a laser beam emitted from the laser light source 109 to detect the regularly reflected light from the cantilever 10 with the displacement sensor 110. The signal output from the displacement sensor 110 is transmitted to the control unit 30 through the differential amplifier 111, the DC converter 112, and the feedback controller 113. Then the output signal is processed by the control unit 30.

In response to a signal 301 from the control unit 30, the probe unit 140 applies electric power and laser light to a test element to be inspected of the row bar 40 placed on the placement unit 114, so that the test element generates magnetic field and near field light.

The near field light detection optical system 115 detects the near field light generated from the test element of the row bar 40, and outputs a detection signal 302 to the control unit 30.

In response to a signal of the oscillator 102, the piezo driver 107 oscillates a piezo drive signal to drive the X stage 106, the Y stage 105, and the Z stage 104, respectively.

In the configuration described above, the control unit 30 controls the X stage 106, the Y stage 105, and the Z stage 104 by the piezo driver 107 based on the image of the row bar 40 taken by the camera 103, to adjust the position of the row bar 40 to locate the row bar 40 at a predetermined position. When the adjustment of the position of the row bar 40 is completed, the probe unit 140 is driven based on a command from the control unit 30. Then, the tip portion of the probe 141 comes into contact with the magnetic head element electrodes 41 and 42 formed in the row bar 40.

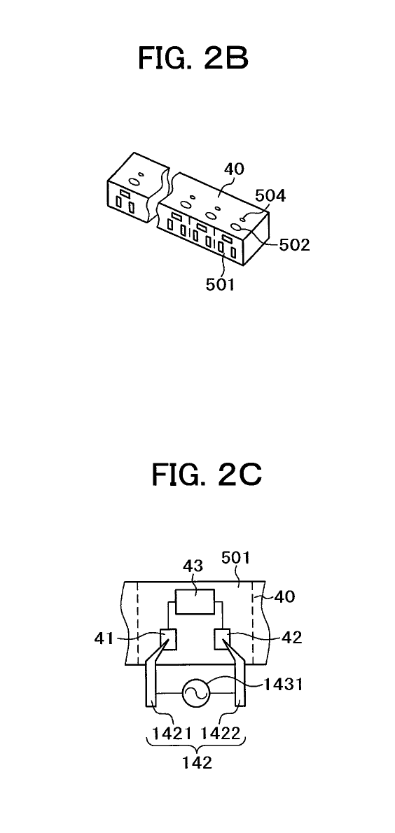

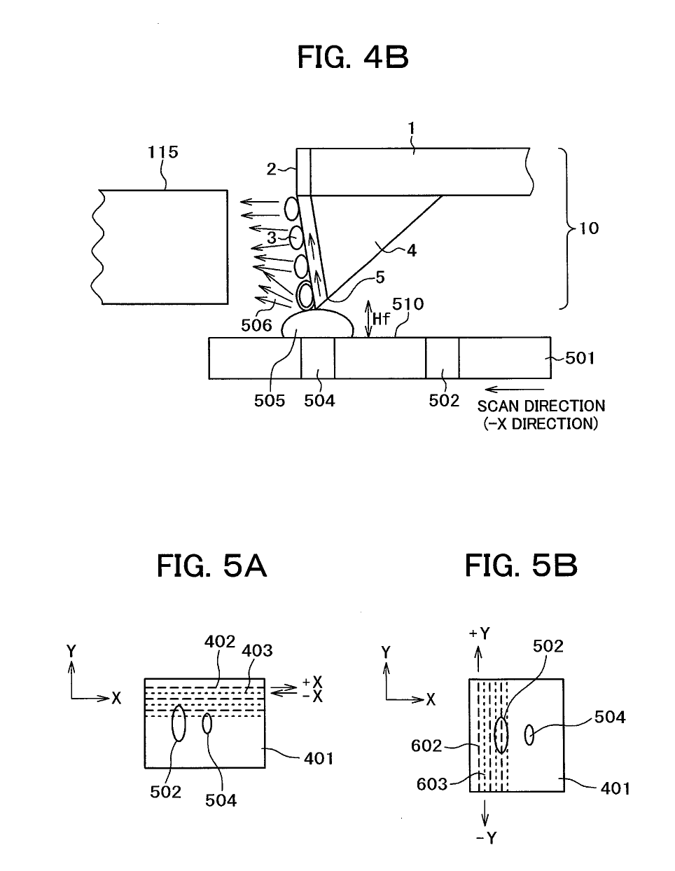

As shown in the side view of FIG. 2A, the probe unit 140 is configured such that a probe card (or substrate) 141 and a probe 142 attached to the probe card 141 are fixed to a probe base 143. The probe base 143 is supported by the inspection stage 101 by a support plate 144. Meanwhile, as shown in the perspective view of FIG. 2B, the row bar 40 is a square bar-shaped substrate in which a large number of magnetic head elements (thermal assist type magnetic head elements) 501 are formed. As shown in FIG. 2C, the tip portions 1421 and 1422 of the probe 142 are brought into contact with the magnetic head electrodes 41 and 42 formed in the row bar 40 of the magnetic head element. In this state, alternating current is applied to the tip portions 1421 and 1422 to generate a magnetic field from the write magnetic field generation part 502 (see FIG. 4A) of a write circuit unit 43. The frequency of the alternating current applied to the row bar 40 is set to a value different from the resonant frequency of the cantilever 10, so that the vibration of the cantilever 10 is not influenced by the frequency of the applied alternating current. Note that the row bar 40 also includes a connection pad to connect to a laser driver 531, which is not shown in the figure.

In such a state, a scan area 401 including the write magnetic field generation part 502 is scanned with the cantilever 10 by driving the X stage and the Y stage. Then, the change in the amplitude of the cantilever 10 is detected by the displacement detection unit 130. Then, the obtained signal is processed by the control unit 30. In this way, it is possible to fast measure the distribution of the magnetic field generated from the write magnetic field generation part 502 of the row bar 40. Thus, the write track width can be measured. The row bar 40 is absorbed and held by an absorption unit, not shown, provided in the placement unit 114.

The probe card 141 can be moved in the X direction by the drive unit 143. The drive unit 143 drives the prove card 141 so that the tip portions 1421 and 1422 sequentially contact and separate from the magnetic head element electrodes 41 and 42 formed in the row bar 40.

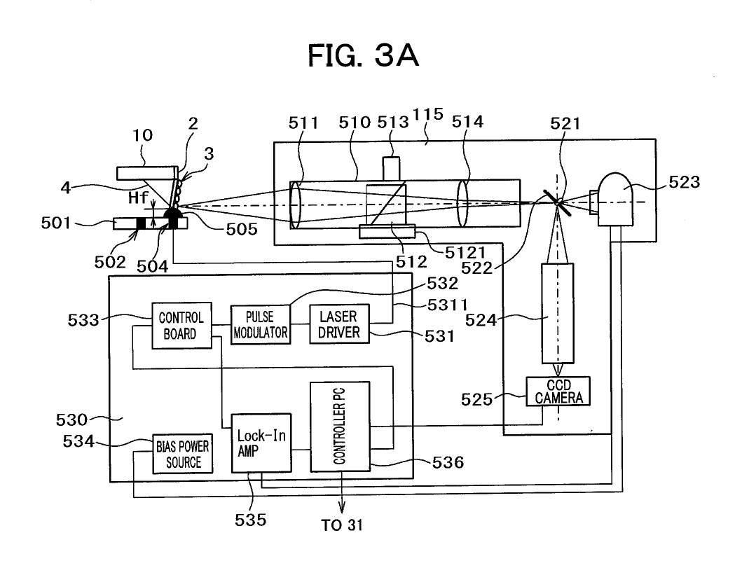

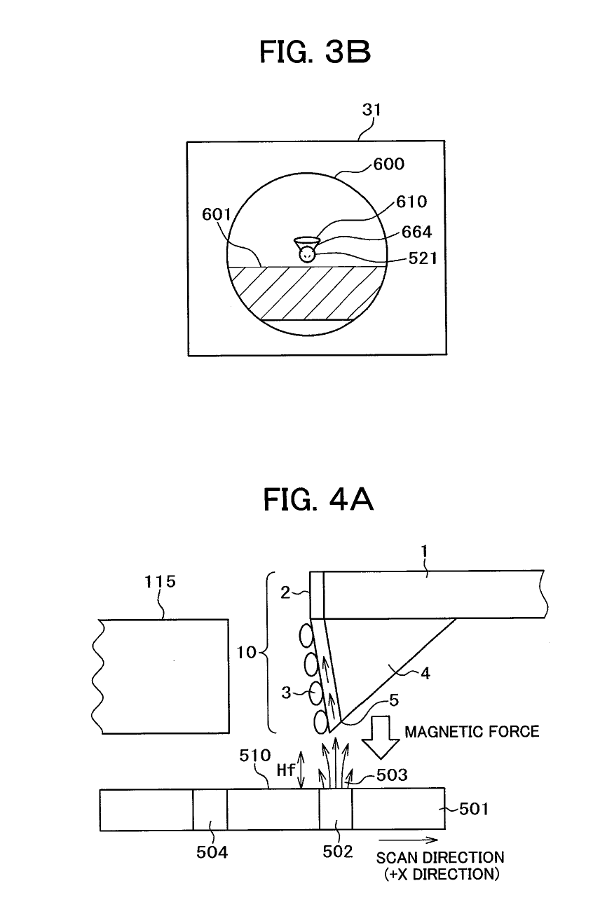

FIG. 3A shows a detailed configuration of the near field light detection optical system 115, in which the relationship between the cantilever 10 and the near field light detection control system 530 within the control unit 30 will be described. Note that the relationship of the positions of the row bar 40, the cantilever 10, and the near field light detection optical system 115 shown in FIG. 3A is reversed to that shown in FIG. 1A.

The cantilever 10 is positioned by the Z stage 104 so that a tip portion 5 of a probe 4 formed in the vicinity of the tip portion of the cantilever 10 is located at the height corresponding to the head fly height Hf from the surface of the thermal assist type magnetic head element 501 formed in the row bar 40. A thin magnetic film 2 (for example, Co, Ni, Fe, NiFe, CoFe, NiCo, and the like), as well as fine particles or thin film 3 of a noble metal (for example, gold, silver, or white gold and the like) or an ally containing a noble metal, are formed on the surface of the probe 4.

The write magnetic field generation part 502 and the near field light generation part 504 are formed in the thermal assist type magnetic head element 501.

The near field light detection optical system 115 includes: an imaging lens system 510 having an objective lens 511, a half mirror 512, an LED light source 513, and an imaging lens 514; a pinhole mirror 522 in which a pinhole 521 is formed in the central part of the mirror; a light detector 523 for detecting light passing through the pinhole 521 of the pinhole mirror 522; a relay lens system 524 for forming an optical image that is formed by the imaging lens system 510 and reflected by the pinhole mirror 522; and a CCD camera 525 for detecting the optical image formed by the relay lens system 524.

Further, the near field light detection control system 530, which is a part of the control unit 30, includes a laser driver 531 for applying a pulse drive current or pulse drive voltage 5311 to the near field light generation part 504 through a waveguide, not shown, in order to generate a near field light 505 from the near field light generation part 504 of the thermal assist type magnetic head element 501. Further, the near field light detection control system 530 also includes: a pulse modulator 532 for adjusting the oscillation frequency of the pulse drive current or pulse drive voltage 5311 oscillated from the laser driver 531; a control board 533 for controlling the laser driver 531 and the pulse modulator 532; a bias power source 534 for applying a bias voltage to the light detector 523; a lock-in amplifier 535 for extracting the signal synchronized with the vibration of the cantilever 10 from the signal detected by the light detector 523; and a controller PC 536 for receiving and processing the output signal which is detected by the lock-in amplifier 535 and output from the light detector 523, as well as the output signal from the CCD camera 525. The output from the controller PC 536 is displayed on a monitor screen 31 of the control unit 30.

As described above, in the configuration of the near field light detection optical system 115 and the near field light detection control system 530, the pulse drive current or pulse drive voltage 5311, which is controlled by a pulse modulation signal from the pulse modulator 532 controlled by the control board 533, is output from the laser driver 531 to apply a pulse laser to the near field light generation part 504 of the thermal assist type magnetic head element 501, through the waveguide not shown. In this way, the near field light 505 is generated on the surface of the thermal assist type magnetic head element 501.

The near field light 505 itself is generated only in the limited area on the surface of the near field light generation part 504. However, when the fine particles or thin film 3 of a noble metal or an alloy containing a noble metal, which is formed on the magnetic film 2 of the surface of the probe 4 of the cantilever 10, enters the generation area of the near field light 505, scattered light of the near field light 505 is generated from the fine particles or thin film 3 of a noble metal or an alloy containing a noble metal. Some of the generated scattered light is incident on the objective lens 511 of the imaging lens system 510 and passes through the half lens 512 to form a scattered light image on the surface of the probe 4 of the cantilever 10, on the imaging surface of the imaging lens 514.

The pinhole mirror 522 is placed so that the pinhole 521 is located in the area where the scattered light image on the surface of the probe 4 is formed on the imaging surface. The size of the probe 4 is sufficiently small compared to the size of the pinhole 521, so that the scattered light image on the surface of the probe 4 can pass through the pinhole 521 and can be detected by the light detector 523. On the other hand, the light, which is noise, from somewhere other than the surface of the probe 4 arrives at the position distant from the pinhole 521 on the imaging surface. Thus, the light, which is noise, is prevented from passing through the pinhole 521 and from reaching the light detector 523. With this configuration, it is possible to detect the emission intensity of the scattered light generated on the surface of the probe 4 by the near field light that is generated from the near field light generation part 504 of the thermal assist type magnetic head element 501, while reducing the influence of the light as the noise.

Meanwhile, some of the light emitted from the LED light source 513 is reflected on the side of the objective lens 511 by the half mirror 512, passing through the objective lens 511 to illuminate the probe 4 of the cantilever 10 as well as the thermal assist type magnetic head element 501. The image in the area irradiated with the illumination light is formed in the vicinity of the surface on which the pinhole mirror 522 is placed, by the imaging lens system 510. Then, the image reflected by the pinhole mirror 522 is incident on the relay lens 524 and is formed again on the output side of the relay lens 524. The detection surface of the CCD camera 525 is placed to match the imaging surface on the output side of the relay lens 524, so that the image of the probe 4 of the cantilever 10 as well as the thermal assist type magnetic head element 501 is taken by the CCD camera 525.

The image is taken by the CCD camera 525 before the inspection of the thermal assist type magnetic head element 501 is started, in which the near field light 503 is not generated from the near field light generation part 504.

The image taken by the CCD camera 525 is the image in which the part of the pinhole 521 of the pinhole mirror 522 is missed. Thus, as shown in FIG. 3B, the image 600 is enlarged and displayed on the monitor screen 31 in order to check the generation position of the scattered light passing through the pinhole 521 in an image 601 of the thermal assist type magnetic head element 501, which includes images 610 and 664 of the cantilever 10 and the probe 4. Then, if the position of the pinhole 521 is displaced from the probe 4, the positions of the near field light detection optical system 115, the pinhole 521 of the pinhole mirror 522, and the light detector 523 are mutually adjusted by checking the image taken by the CCD camera 525, on the monitor screen 31. With this adjustment, it is possible to allow the scattered light generated from the probe 4 to pass through the pinhole 521 and to be detected by the light detector 523.

The imaging lens system 510 includes a drive unit 5121 for removing the half mirror 512 from the optical axis of the imaging lens system 510. First, the half mirror 512 is placed on the optical axis of the imaging lens system 510. In this state, the image taken by the CCD camera 525 is displayed on the monitor screen 31 to check and adjust the position of the pinhole 521. Next, after the position of the pinhole 521 is checked and adjusted, the half mirror 512 is removed from the optical axis of the imaging lens system 510 by the drive unit 5121, and a large number of thermal assist type magnetic head elements 501 formed in the row bar 40 are sequentially inspected. In other words, the half mirror 512 is located on the optical axis of the imaging lens system 510 when the position of the pinhole 521 is checked and adjusted. Then, the half mirror 512 is moved to a position out of the optical axis of the imaging lens system 510, when a large number of thermal assist type magnetic head elements 501 formed in the row bar 40 are sequentially inspected. In this way, when the thermal assist type magnetic head elements 501 are sequentially inspected, the half mirror 512 is moved to a position out of the optical axis of the imaging lens system 510, so that it is possible to detect the scattered light generated from the probe 4 of the cantilever 10 by the light detector 523, without halving the amount of the scattered light by the half mirror 512 in the inspection of the thermal assist type magnetic head elements. As a result, the scattered light generated from the probe 4 can be detected more sensitively.

In the state in which the near field light detection optical system 115 is configured as described above, the probe 141 of the probe unit 140 is driven by the drive unit 143 under the control of the control unit 30, so that the tip portions 1421 and 1422 of the probe 141 come into contact with the magnetic head element electrodes 41 and 42 formed in the row bar 40, respectively. Further, the waveguide from the laser driver 531, not shown, is coupled to the near field light generation part 504 of the thermal assist type magnetic head element 501.

In this way, the signal 301 (alternating current 1431 and the pulse drive current or pulse drive voltage 5311) output from the control unit 30 can be supplied to the thermal assist type magnetic head element formed in the row bar 40. In this state, the thermal assist type magnetic head element 501 to be inspected of the row bar 40, which is absorbed and held by the absorption unit not shown provided in the placement unit 114, is ready to generate a magnetic field from the write magnetic generation part 502 and to emit a near field light from the near field light emitting part 504.

As shown in FIG. 4A, the cantilever 10 that can measure both the near field light and magnetic field is provided at the corresponding position above the row bar 40 placed on the Y stage 105 of the inspection stage 101. The cantilever 10 is attached to the vibration unit 122 provided on the lower side of the Z stage 104. The vibration unit 122 is realized by the piezo element, in which AC voltage with a frequency around the mechanical resonance frequency of the cantilever 10 is applied by the vibration voltage from the piezo driver 107 to vibrate the cantilever 10. Then, the probe 4 at the tip portion of the cantilever 10 vibrates in the up and down direction (in the Z direction).

As shown in FIGS. 4A and 4B, according to the present embodiment, the probe 4 of the cantilever 10 is formed with a tetrahedral structure in the tip portion of a bar-shaped lever 1 of the cantilever 10. The lever 1 and the probe 4 are formed from silicon (Si). The thin magnetic film 2 is formed on the front side of the lever 1 and the probe 4 (on the side facing the near field light detection optical system 115: on the left side of FIGS. 4A and 4B). Then, the fine particles or thin film 3 of a noble metal or an alloy containing a noble metal is formed on the surface of the magnetic film 2. The cantilever 10 includes the lever 1, the probe 4, the thin magnetic film 2, and the particles or thin film 3 of a noble metal, so that it is possible to measure both the near field light and the magnetic field.

In other words, the thin magnetic film 2 formed on the surface of the probe 4 determines the sensitivity and resolution for measuring the magnetic field, sensing the magnetic field of the subject to be measured when the magnetic field 503 generated in the magnetic field generation part 502 is measured. Further, the fine particles or thin film 3 of a noble metal (for example, gold, silver, and the like) or an alloy containing a noble metal, which is formed on the surface of the probe 4, amplifies the scattered light generated from the fine particles or thin film 3 when the probe 4 enters the generation area of the near field light 506, by the localized surface plasmon enhancing effect, so that the amount of light is enough to be detected by the near field light detection optical system 115. However, the fine particles or thin film 3 of a noble metal or an alloy containing a noble metal is not necessarily used. If the magnetic film 2 is sufficiently thin, it is also possible to amplify the scattered light 506 generated from the surface of the probe 4 by the near field light so that the amount of light is enough to be detected by the near field light detection optical system 115, by the localized surface plasmon enhancing effect when the near field light 505 hits the magnetic film 2.

The vibration in the Z direction of the probe 4 of the cantilever 10 is detected, as shown in FIG. 1A, by the displacement detection unit 130 including a semiconductor laser device 109 and a displacement sensor 110 of a four-segment photodetector device. In the displacement detection unit 130, a laser beam output from the semiconductor laser device 109 illuminates the surface opposite the surface on which the probe 4 of the cantilever 10 is formed. Then, the laser beam reflected from the cantilever 10 is incident on the displacement sensor 110. The displacement sensor 110 is a four-segment sensor in which the light receiving surface is divided into four areas. The laser beam is incident on the divided light receiving surfaces of the displacement sensor 110, respectively, and photo-electrically converted and output as four electrical signals.

Here, the displacement sensor 110 has the light receiving surface that is divided into four segments. The displacement sensor 110 is positioned so that when the cantilever 10 is not vibrated by the vibration unit 122, to namely, in a static state, the laser beam emitted from the semiconductor laser device 109 and reflected from the cantilever 10 is incident on the respective four segments of the receiving surface equally. The differential amplifier 111 applies a predetermined arithmetic operation to the four electrical signals output from the displacement sensor 110. Then, the differential amplifier 111 outputs the result to the DC converter 112.

In other words, the differential amplifier 111 outputs the displacement signal corresponding to the difference of the four electrical signals output from the displacement sensor 110, to the DC converter 112. Thus, when the cantilever 10 is not vibrated by the vibration unit 122, the output from the differential amplifier 111 is zero. The DC converter 112 includes an RMS-DC converter (Root Mean Squared value to Direct Current converter) that converts the displacement signal output from the differential amplifier 111 into DC signal by the effective value of the displacement signal.

The displacement signal output from the differential amplifier 111 is a signal corresponding to the displacement of the cantilever 10, which is an AC signal because the cantilever 10 vibrates during the inspection. The signal output from the DC converter 112 is input to the feedback controller 113. The feedback controller 113 outputs the signal output from the DC converter 112, to the control unit 30 as the signal for monitoring the magnitude of the current vibration of the cantilever 10. At the same time, the feedback controller 113 outputs the signal input from the DC converter 112, to the piezo driver 107 through the control unit 30 as the signal for controlling the Z stage 104 in order to adjust the magnitude of the vibration of the cantilever 10. The signal is monitored by the control unit 30 to control the piezo element (not shown) that drives the Z stage 104, by the piezo driver 107 according to the monitored value. Thus, the initial position of the cantilever 10 is adjusted before the measurement is started.

The near field light is generated from the near field light generation part 504 by the pulse drive current or pulse drive voltage 5311 oscillated from the laser driver 531.

In the present embodiment, the X stage 106 and the Y stage 105 are driven by the piezo driver 107 in the state in which the cantilever 10 is vibrated by the vibration unit 122 with a predetermined frequency. In this way, as shown in FIG. 5A, the inspection area 401 of the thermal assist type magnetic head element 501 is scanted with the cantilever 10. The inspection area 401 is the area where the length of one side is in the range from hundreds of nm to several μm.

When the X stage 106 is moved by vibrating the cantilever 10 in the up and down direction to the inspection area 401, the surface of the inspection area 401 is scanned with the probe 4 from the left side to the right side in the figure along a dotted line 402 in the X direction (namely, by moving the thermal assist type magnetic head element 501 in the +X direction as shown in FIG. 4A). In this case, a magnetic field is generated from the write magnetic field generation part 502 of the thermal assist type magnetic head element 501. Then, the generated magnetic field is detected by driving the cantilever 10 in a magnetic force microscope (MFM) mode. During the inspection in the MFM mode, the output of the laser to the near field light emitting part 504 from the laser driver 531 is stopped.

On the other hand, when the X stage 106 is scanned from the right side to the left side in the figure along a dotted line 403 in the X direction (namely, by moving the thermal assist type magnetic head element 501 in the −X direction as shown in FIG. 4B), the surface roughness of the inspection area 401 is measured by driving the cantilever 10 in an atomic force microscope (AFM) mode, without generating the magnetic field from the write magnetic field generation part 502 of the thermal assist type magnetic head element 501. At the same time, the laser beam is output from the laser driver 531 to the near field light emitting part 504, to generate a near field light from the near field light emitting part 504. Then, the generated near field light is detected by the near field light detection optical system 115.

As described above, in the inspection, the MFM mode inspection and the AFM mode inspection are switched according to the scan direction in the X direction of the thermal assist type magnetic head element 501 with respect to the cantilever 10. During the inspection in the MFM mode, the application of the pulse drive current or pulse drive voltage 5311 to the near field light emitting part 504 is stopped. In this way, it is possible to prevent the temperature of the thermal assist type magnetic head element 501 from increasing due to the heat generated by the near field light emitting part 504. Thus, it is possible to avoid the occurrence of damage to the thermal assist type magnetic head element 501.

In the MFM mode and in the AFM mode, the height of the probe 4 of the cantilever 10 is changed relative to the surface of the inspection area 401 of the thermal assist type magnetic head element 501. In other words, when the inspection is performed in the AFM mode, the height of the probe 4 of the cantilever 10 relative to the surface of the inspection area 401 of the thermal assist type magnetic head element 501, is set to the height corresponding to the head fly height Hf in the writing to the magnetic disk. On the other hand, when the inspection is performed in the MFM mode, the height of the probe 4 is set to a value greater than Hf (so that the gap between the surface of the inspection area 401 and the tip portion of the probe 4 is increased). The height changed is performed by driving the Z stage 104 by the piezo driver 107.

Note that in the example shown in FIG. 5A, although the neighboring dotted lines 402 and 403 are shown so that the surface of the inspection area 401 is scanned in different positions in the Y direction, it is also possible to scan the surface in the same position in the Y direction, namely, where the dotted lines 402 and 403 overlap each other. In this case, first the AFM mode inspection is performed by moving the thermal assist type magnetic head element 501 along the dotted line 402. Then, the MFM mode inspection is performed by moving the thermal assist type magnetic head element 501 in the opposite direction along the dotted line 403. Next, the thermal assist type magnetic head element 501 is moved by 1 pitch in the Y direction to perform the AFM mode inspection and the MFM mode inspection.

Next will be described a method for detecting the magnetic field generated from the thermal assist type magnetic head element 501 in the MFM mode inspection.

First, the Z stage 104 is controlled by the piezo driver 107 so that the probe 4 is set to the height position (gap) relative to the thermal assist type magnetic head element 501 for the MFM mode inspection. Meanwhile, the tip portions 1421 and 1422 of the probe 142 are driven by the drive unit 143 of the probe unit 140 to come into contact with the electrodes 41 and 42 formed in the row bar 40, respectively. In this state, when the alternating current 1431 is applied, the write magnetic field 503 is generated from the write magnetic field generation part 502 of the write circuit unit 43. At this time, the output of the laser to the near field light generation part 504 from the laser driver 531 is blocked. Next, the cantilever 10 is vibrated by the vibration unit 122. In this state, the X stage 106 on which the row bar 40 is located is moved in the +X direction in FIG. 4A, at a constant speed by the piezo element (not shown) controlled by the piezo driver 107. In this way, the inspection area 401 of the thermal assist type magnetic head element part 501 is scanned by the probe 4 in the direction (+X direction) along the dotted line 402 as shown in FIG. 5A.

When the probe 4 of the cantilever 10 enters the write magnetic field 503 generated from the write magnetic field generation part 502, the thin film of magnetic material 2 formed on the surface of the probe 4 is magnetized. The probe 4 receives a magnetic force, so that the vibration state of the cantilever 10 is changed. This vibration change is detected by the displacement sensor 110 shown in FIG. 1A. In other words, the change in the vibration state of the cantilever 10 changes the incident position of the laser beam emitted from the semiconductor laser device 109, on the four segments of the light receiving surface of the displacement sensor 110.

The output from the displacement sensor 110 is detected by the differential amplifier 111 in order to detect the change in the vibration state of the cantilever 10 according to the scan position. By processing the detected signal by the control unit 30, it is possible to detect the intensity distribution of the write magnetic field 503 generated by the magnetic field generation part 502 of the thermal assist type magnetic head element 501. Further, by comparing the detected intensity distribution of the write magnetic field with a reference value, it is possible to determine the quality of the write magnetic field generation part 502.

The X stage 106 is driven to move the probe 4 by the distance in the X direction of the inspection area 401. Then, the drive of the X stage 106 is stopped to stop the MFM mode inspection. After the mode is switched to AMF mode, the X stage 106 is moved in the opposite direction.

Next will be described a method for detecting the generation state of the near field light from the thermal assist type magnetic head element 501 in the AFM mode inspection. In the AFM mode inspection, the cantilever 10 is driven and vibrated by the vibration unit 122. In this state, the inspection area 401 is scanned by the probe 4 in the −X direction along the dotted line 403. Then, the change in the vibration amplitude of the scanning cantilever 10 is detected by the displacement detection unit 130 to obtain the information of the roughness of the surface of the inspection area 401. At the same time, scattered light is generated from the scanning probe 4 when scanning on the upper surface of the near field light generation part 504. Then, the generated scattered light is detected by the near field light detection optical system 115. In order to perform the AFM mode inspection, first the Z stage 104 is controlled by the piezo driver 107 so that the probe 4 is set to the height position (gap) for the AFM mode relative to the thermal assist type magnetic head element 501. Next, the pulse drive current or pulse drive voltage 5311 output from the laser driver 531 is applied to the near field light generation part 504 of the thermal assist type magnetic head element 501, from the probe unit 140.

In such a state, as shown in FIG. 4B, the cantilever 10 is vibrated in the up and down direction to the surface (recording surface) 510 of the row bar 40, by the vibration unit 122. Then, the X stage 106 on which the row bar 40 is located is scanned by the cantilever 10 at a constant speed in the X direction (−X direction) opposite to the direction in the MFM inspection described above. The change in the vibration of the cantilever 10, which scans the X stage 106, is detected by the displacement sensor 110 of the displacement detection unit 130. Meanwhile, when the probe 4, which scans the X stage 106, arrives at the area where the near field light 505 is generated from the near field light generation part 504, the scattered light 506 is generated from a part of the surface of the probe which is in the area where the near field light 505 of the probe 4 is generated. The scattered light generated on the surface of the probe 4 is amplified by the localized surface plasmon enhancing effect from the fine particles or thin film 3 of a noble metal (for example, gold, silver, and the like) or an alloy containing a noble metal, which is formed on the magnetic film 3 on the surface of the probe 4. Some of the amplified scattered light is incident in the near field light detection optical system 115 located in the vicinity of the cantilever 10, which is then detected by the light detector 523.

The X stage 106 is driven to scan by the distance in the X direction of the inspection area 401 by the probe 4 in the opposite direction to the direction in the MFM mode. Then, the drive of the X stage 106 is stopped to stop the AFM mode inspection. Next, the Y stage 105 is driven to move the inspection area 401 by 1 pitch in the Y direction relative to the probe 4. Then, the X stage 106 is driven in the same direction as the direction in the MFM mode, to scan the inspection area 401 in the X direction by the probe 4. This process is repeated to scan the entire surface of the inspection area 401 by the probe 4.

In this way, the entire surface is scanned once by the probe 4. Thus, it is possible to detect the magnetic field generation area generated from the magnetic generation part 502 of the thermal assist type magnetic head element 501, as well as the generation area of the scattered light from the probe 4 due to the near field light generated from the near field light generation part 504. The detected signal is processed by the control unit 30 in order to obtain the distribution of the magnetic field generated from the magnetic field generation part 502, as well as the distribution of the intensity of the near field light generated from the near field light generation part 504. By comparing the obtained magnetic field distribution and the obtained near field light intensity distribution, with predetermined reference data, it is possible to judge the quality of the state of the magnetic field generated from the magnetic field generation part 502, and the quality of the state of the near field light emitted from the near field light generation part 504 (such as the magnetic field force, the magnetic field distribution, the shape and position of the magnetic field generation area, the near field light intensity, the near field light distribution, and the shape and position of the near field light generation area).

Further, it is also possible to measure the positional relationship between the write magnetic field (AC magnetic field) 503 generated by the magnetic field generation part 502 of the thermal assist type magnetic head element 501, and the thermal assist light (near filed light) 505 generated from the near field light generation part 504. In this way, it is possible to inspect the write magnetic field of the thermal assist type magnetic head element 501, as well as the distribution of the intensity of the near field light, and to measure the positional relationship between them in a stage as early as possible in the manufacturing process.

First, upon performing the inspection, as described above, the positions of the probe 4, the pinhole 521 of the pinhole mirror 522, and the light detector 523 in the AFM mode inspection are adjusted in advance by monitoring the image taken by the CCD camera 525 of the near field light detection optical system 115 and displayed on the monitor screen 31.

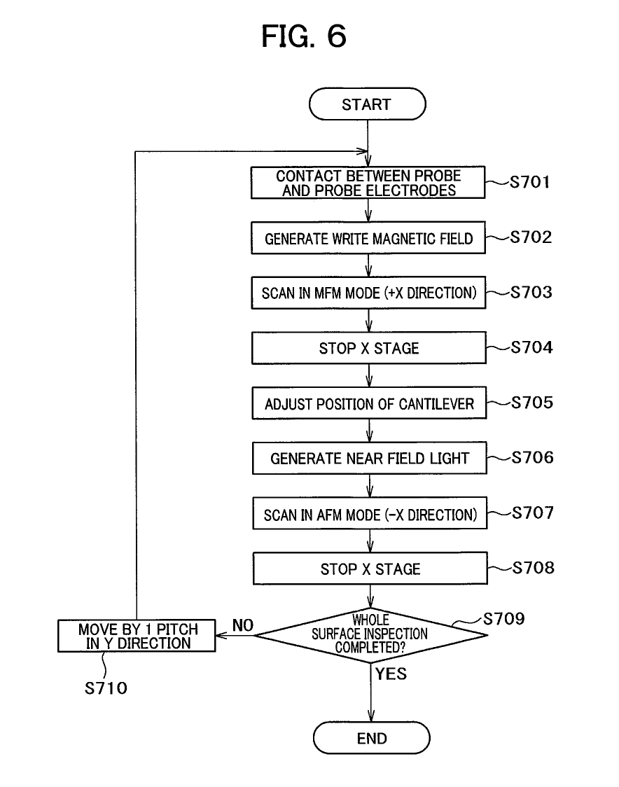

In the state in which the near field light detection optical system 115 is adjusted as described above, the inspection is performed by the procedure shown in FIG. 6. In the inspection, first the Z stage is driven so that the cantilever 10 approaches the position to be inspected in the MFM mode in the inspection area 401 of the recording surface 510 of the thermal assist type magnetic head element 501. Then, the drive unit 143 of the probe unit 140 is driven to move the probe 141 forward, so that the tip portions 1411 and 1412 of the probe 141 are brought into contact with the magnetic head element electrodes 41 and 42 of the thermal assist type magnetic head element 501 formed on the row bar 40 (S701). Then, the signal 301 is supplied to the thermal assist type magnetic head element 501 to generate the write magnetic field (AC magnetic field) 503 from the magnetic field generation part 502 (S702).

Next, the cantilever 10 is vibrated by the vibration unit 122. At the same time, the piezo element (not shown) is driven by the piezo driver 107 to move the x stage 106 in the X direction at a constant speed. In this state, the inspection area 401 is scanned in the MFM mode by the cantilever 10 (S703). When the probe 4 of the cantilever 10 arrives at the end of the inspection area 401 in the X direction, the drive of the X stage 106 is stopped (S704). Next, the Z stage is driven to adjust the position of the cantilever 10 so that the distance between the probe 4 and the recording surface 510 of the thermal assist type magnetic head element 501 is equal to the distance in the AFM mode (S705). Then, the pulse drive current or pulse drive voltage 5311 is applied to the near field light generation part 504 from the probe unit 140 to generate a near field light around the near field light generation part 504 inside the inspection area 401 (S706).

Next, the cantilever 10 is vibrated by the vibration unit 122. At the same time, the piezo element (not shown) is driven by the piezo driver 107 to move the X stage 106 in the −X direction at a constant speed. In this state, the inspection area 401 is scanned by the cantilever 10 in the AMF mode (S707). When the probe 4 of the cantilever 10 arrives at the end of the inspection area 401 on the opposite side in the X direction, the drive of the X stage 106 is stopped (S708).

Next, whether the inspection of the entire surface of the inspection area 402 is completed is checked (S709). If the inspection of the entire surface has not been completed (No in S709), the piezo element (not shown) is driven by the piezo driver 107 to move the Y stage 105 by one pitch in the Y direction (S710), and the steps from S701 to S709 are performed.

By performing the steps from S701 to S709, it is possible to detect the distribution of the write magnetic field 503 generated from the magnetic field generation part 502 of the thermal assist type magnetic head element 501, as well as the shape of the generation area of the near field light 505 generated from the near field generation part 504, by scanning the entire surface of the inspection area 401 by the probe 4 only once. Then, by processing the detected signal by the controller PC 536, it is possible to obtain the information of the position of the magnetic field generation part 502, the information of the distribution of the magnetic field generated by the magnetic field generation part 502, the information of the position of the near field light emitting part 504 from the distribution of the intensity of the thermal assist light (near field light) 505, and the information of the surface shape of the inspection area 401. Further, the relationship between the positions of the magnetic field generation part 502 and the near field light emitting part 504 is obtained from the information of the position of the magnetic field generation part 502 and from the information of the position of the near field light emitting part 504, in order to check whether the distance between the magnetic field generation part 502 and the near field light emitting part 504 is a predetermined distance.

According to the present embodiment, the thermal assist type magnetic head inspection apparatus 100 can detect the write magnetic field (AC magnetic field) generated from the thermal assist type magnetic head element 501 formed in the row bar 40, as well as the thermally assisted light (near field light) by scanning the entire surface of the inspection area only once by the cantilever 10. Thus, the inspection can be performed in the upstream of the manufacturing process in a relatively short time.

Further, according to the present embodiment, it is possible to check the position detected by the light detector through the pinhole based on the image displayed on the monitor screen, so that the positions of the probe and the pinhole can easily be adjusted. As a result, the time for the position adjustment can be significantly reduced compared to the case without using the monitor image. In addition, because the detection position can be adjusted by displaying the image on the monitor screen, it is possible to achieve sufficiently high accuracy in the positioning of the probe and the pinhole.

Note that the above embodiment has described an example of inspecting the thermal assist type magnetic head element 501 formed in the row bar 40. However, it is also possible to inspect the thermal assist type magnetic head element 501 in a state of head assembly in which the thermal assist type magnetic head element 501 is mounted on a gimbal, not shown, in the same manner as described above. In this case, the shape of the placement unit 114 is changed so that the head assembly can be placed on it.

Next, another embodiment different from the above embodiment will be described. The difference from the above embodiment is that although the inspection area 401 of the thermal assist type magnetic head element 501 is scanned by the cantilever 10 in the X direction and the −X direction in the above embodiment as shown in FIG. 5A, the inspection area 401 of the thermal assist type magnetic head element 501 is scanned by the cantilever 10 in the Y direction and the −Y direction in the other embodiment as shown in FIG. 5B.

When the Y stage 105 is moved by vibrating the cantilever 10 in the up and down direction relative to the inspection area 401, the inspection area 401 is scanned by moving the probe 4 from the top to the bottom in the figure along a dotted line 602 in the Y direction (by moving the thermal assist type head element 501 downward in the direction perpendicular to the paper in FIG. 4A). In this case, the magnetic field is generated from the write magnetic field generation part 502 of the thermal assist type magnetic head element 501. Then, the generated magnetic field is detected by driving the cantilever 10 in the MFM mode. During the inspection in the MFM mode, the output of the laser to the near field light emitting part 504 from the laser driver 531 is stopped.

On the other hand, when the Y stage 105 is scanned from the bottom to the top in the figure along a dotted line 603 in the Y direction (by moving the thermal assist type head element 501 upward in the direction perpendicular to the paper in FIG. 4B), the surface roughness of the inspection area 410 is measured by driving the cantilever 10 in the AFM mode, without generating the magnetic field from the write magnetic field generation part 502 of the thermal assist type magnetic head element 501. At the same time, the laser beam is output to the near field light emitting part 504 from the laser driver 531 to generate a near field light from the near field light generation part 504. Then, the generated near field light is detected by the near field light detection optical system 115.

As described above, the inspection is performed by switching between the MFM mode and the AFM mode according to the scan direction in the Y direction of the thermal assist type magnetic field element 501 with respect to the cantilever 10. During the inspection in the MFM mode, the application of the pulse drive current or the pulse drive voltage 5311 to the near field light emission part 504 is stopped. Thus, it is possible to prevent the temperature of the thermal assist type magnetic head element 501 from increasing due to the heat generated by the near field light emitting part 504. As a result, it is possible to avoid the occurrence of damage to the thermal assist type magnetic head element 501.

In the MFM mode and in the AFM mode, the height of the probe 4 of the cantilever 10 relative to the surface of the thermal assist type magnetic head element 501 is switched. In other words, when the inspection is performed in the AFM mode, the height of the probe 4 of the cantilever 10 relative to the surface of the inspection area 401 of the thermal assist type magnetic head element 501 is set to the height corresponding to the head fly height Hf in the writing to the magnetic disk. On the other hand, in the MFM mode, the height of the probe 4 is set to the height greater than Hf (so that the gap between the surface of the inspection area 401 and the tip portion of the probe 4 is increased). The switching of the height is performed by driving the Z stage 104 by the piezo driver 107.

Note that, similar to the example shown in FIG. 5A, in the example shown in FIG. 5B, neighboring dotted lines 602 and 603 are shown so that the surface of the inspection area 401 is scanned in different positions in the Y direction. However, it is also possible to scan the surface in the same position in the Y direction, namely, where the dotted lines 602 and 603 overlap each other. In this case, first the thermal assist type magnetic head element 501 is moved along the dotted line 602 to perform the inspection in the AFM mode. Then, the inspection in the MFM mode is performed by moving the thermal assist type magnetic head element 501 in the opposite direction along the dotted line 603. Next, the thermal assist type magnetic element 501 is moved by one pitch in the X direction to perform the AFM mode inspection and the MFM mode inspection. Further, it is also possible that the laser driver 531 applies a constant current or voltage, instead of applying the pulse drive current or pulse drive voltage, to generate the near field light 505 from the near field light generation part 504 of the thermal assist type magnetic head element 501.

In the foregoing, the invention made by the inventors of the present invention has been concretely described based on the embodiments. However, it is needless to say that the present invention is not limited to the foregoing embodiments and various modifications and alterations can be made within the scope of the present invention.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

1. An apparatus for inspecting a thermal assist type magnetic head, comprising:
a scanning probe microscope including an XY table that can be moved in an XY plane with a thermal assist type magnetic head element placed on it, and a cantilever having a probe with a magnetic film formed on a surface of a tip portion;
a probe unit for supplying an alternating current to a terminal formed in the thermal assist type magnetic head element placed on the XY table of the scanning probe microscope, so that the laser beam is incident on a near field light emitting part formed in the thermal assist type magnetic head element;
an imaging unit for taking an image of the probe unit and the thermal assist type magnetic head element;
an image display unit for displaying the image of the probe unit and the thermal assist type magnetic head element taken by the imaging unit;
a scattered light detection unit including a light detector for detecting scattered light generated by the probe through a pinhole, when the probe is present in the generation area of the near field light generated from the near field light emitting part formed in the thermal assist type magnetic head element; and
a signal processing unit for inspecting the thermal assist type magnetic head element, by using the output signal output from the scanning probe microscope by scanning the surface of the thermal assist type magnetic head element by the probe of the cantilever while the alternating current is supplied to the terminal from the probe unit, and by using the output signal output from the scattered light detection unit by scanning the surface of the thermal assist type magnetic head element by the cantilever while the laser beam is incident on the near field light emitting part from the probe unit.

2. The apparatus for inspecting a thermal assist type magnetic head according to claim 1,
wherein the imaging unit and the scattered light detection unit partially share an optical path,
wherein the shared optical path is divided by a mirror with the pinhole,
wherein the scattered light detection unit detects scattered light passing through the pinhole,
wherein the imaging unit takes an image of the light reflected from the mirror with the pinhole.

3. The apparatus for inspecting a thermal assist type magnetic head according to claim 1,
wherein the imaging unit includes:
a light source;
a half mirror placed on the optical axis of the objective lens to reflect light emitted from the light source to illuminate the probe unit and the thermal assist type magnetic head element, through the objective lens;
a relay lens for forming an image by illuminating the probe unit and the thermal assist type magnetic head element with the light from the light source by the half mirror, collecting the reflected light from the probe unit and the thermal assist type magnetic head element by the objective lens, and reflecting the light passing through the half mirror by the mirror with the pinhole; and
a camera for taking an image formed by the relay lens.

4. The apparatus for inspecting a thermal assist type magnetic head according to claim 2,
wherein the imaging unit includes:
a light source;
a half mirror placed on an optical axis of the objective lens to reflect the light emitted from the light source to illuminate the probe unit and the thermal assist type magnetic head element, through the objective lens;
a relay lens for forming an image by illuminating the probe unit and the thermal assist type magnetic head element with the light from the light source by the half mirror, collecting the reflected light from the probe unit and the thermal assist type magnetic head element by the objective lens, and reflecting the light passing through the half mirror by the mirror with the pinhole; and
a camera for taking an image formed by the relay lens.

5. The apparatus for inspecting a thermal assist type magnetic head according to claim 1,
wherein particles of a noble metal or an alloy containing a noble metal are formed on a magnetic film formed on the surface of the probe.

6. The apparatus for inspecting a thermal assist type magnetic head according to claim 2,
wherein particles of a noble metal or an alloy containing a noble metal are formed on a magnetic film formed on the surface of the probe.

7. A method for inspecting a thermal assist type magnetic head, comprising the steps of:
placing a thermal assist type magnetic head element on an XY table of a scanning probe microscope including a cantilever having a prove with a magnetic film formed on the surface of the tip portion, and the XY table that can be moved in an XY plane;
generating a magnetic field in the thermal assist type magnetic head element by supplying an alternating current to a terminal formed in the thermal assist type magnetic head element placed on the XY table;
obtaining the distribution of the magnetic field generated by scanning the surface of the thermal assist type magnetic head element by the probe of the cantilever of the scanning probe microscope, while the magnetic field is generated in the thermal assist type magnetic head element;
generating a near field light from a near field light emitting part formed in the thermal assist type magnetic head element placed on the XY table, by a laser beam incident on the near field light emitting part;
scanning the surface of the thermal assist type magnetic head element by the probe of the cantilever of the scanning probe microscope while the near field light is generated from the near field light emitting part, to collect the scattered light generated from the probe in the generation area of the near field light by an objective lens;
detecting the scattered light passing through a pinhole, of the collected scattered light;
obtaining the light emitting area and distribution of the near field light from the detected scattered light; and
determining the quality of the thermal assist type magnetic head based on the information of the obtained distribution of the magnetic field, and on the information of the obtained light emitting area and distribution of the near field light.

8. The method for inspecting a thermal assist type magnetic head according to claim 7,
wherein the position of the pinhole is adjusted by displaying the image of the thermal assist type magnetic head including the pinhole on a monitor screen.

9. The method for inspecting a thermal assist type magnetic head according to claim 7,
wherein particles of a noble metal or an alloy containing a noble metal are formed on a magnetic film formed on the surface of the probe,
wherein, when a part of the probe is present in the near field light generated from the near field light emitting part, scattered light is generated and amplified by the localized surface plasmon enhancing effect from the particles of a noble metal or an alloy containing a noble metal.

10. The method for inspecting a thermal assist type magnetic head according to claim 7,
wherein the entire surface of the inspection area located on the thermal assist type magnetic head element is scanned once to obtain the magnetic field distribution as well as the light emitting area and distribution of the near field light in the inspection area.

11. A method for inspecting a thermal assist type magnetic head, comprising the steps of:
placing a thermal assist type magnetic head element on an XY table of a scanning probe microscope including a cantilever having a probe with a magnetic field formed on the surface of the tip portion, and the XY table that can be moved in an XY plain;
detecting the magnetic field generation area by scanning the surface of the thermal assist type magnetic head placed on the XY table, by the probe of the cantilever of the scanning probe microscope in a first direction, while the magnetic field is generated in the thermal assist type magnetic head element by supplying an alternating current to a terminal formed in the thermal assist type magnetic head element;
scanning the surface of the thermal assist type magnetic head element placed on the XY table, by the probe of the cantilever of the scanning probe microscope in a second direction opposite to the first direction, while the near field light is generated from the near field light emitting part by a laser beam incident on a near field light emitting part formed in the thermal assist type magnetic head element;
collecting the scattered light generated from the probe in the generation area of the near field light by an objective lens;
detecting the scattered light passing through a pinhole, of the collected scattered light;
obtaining the light emitting area of the near field light from the detection signal of the scattered light; and
determining the quality of the thermal assist type magnetic head, based on the information of the detected magnetic field generation area and on the information of the obtained near field light emitting area.

12. The method for inspecting a thermal assist type magnetic head according to claim 11,
wherein the position of the pinhole is adjusted by displaying the image of the thermal assist type magnetic head including the pinhole, on a monitor screen.

13. The method for inspecting a thermal assist type magnetic head according to claim 11,
wherein particles of a noble metal or an alloy of a noble metal are formed on a magnetic film formed on the surface of the probe,
wherein, when a part of the probe is present in the near field light generated in the near field light emitting part, scattered light is generated and amplified by the localized surface plasmon enhancing effect from the particles of a noble metal or an alloy of a noble metal.

14. The method for inspecting a thermal assist type magnetic head according to claim 11,
wherein the entire surface of the inspection area located on the thermal assist type magnetic head element is scanned once, to obtain the magnetic field distribution as well as the light emitting area and distribution of the near field light in the inspection area.
